(19) United States
(12) Patent Application Publication
(10) Pub. No.: US 2024/0105998 A1
(43) Pub. Date: Mar. 28, 2024

(54) HIGH ENERGY METAL SULFUR OR SELENIUM-SULFUR BATTERY

(71) Applicant: UCHICAGO ARGONNE, LLC, Chicago, IL (US)

(72) Inventors: Guiliang Xu, Naperville, IL (US); Chen Zhao, Woodridge, IL (US); Khalil Amine, Oakbrook, IL (US)

(73) Assignee: UCHICAGO ARGONNE, LLC, Chicago, IL (US)

(21) Appl. No.: 17/954,839

(22) Filed: Sep. 28, 2022

(51) Int. Cl. H01M 10/0569; H01M 4/04; H01M 4/136; H01M 4/62; H01M 10/052

(52) U.S. Cl. CPC H01M 10/0569; H01M 4/0435; H01M 4/0471; H01M 4/136; H01M 4/625; H01M 10/052; H01M 2300/0042

(57) ABSTRACT

The present invention provides, in part, an electrochemical energy storage device comprising a metal anode, a separator, a high-mass-loading selenium-sulfur cathode and a lean electrolyte. In particular, the electrolyte described herein employs active solid-electrolyte interphase engineering salts and features unique solvating structure. The combination of high-mass-loading S cathode and the particular electrolytes can enhance one or more of the following cell properties: energy density, cycling stability, safety, and working temperature window.

### STATEMENT OF GOVERNMENT INTEREST

This invention was made with government support under Contract No. DE-AC02-06CH11357 awarded by the U.S. Department of Energy. The government has certain rights in the invention.

### FIELD OF THE INVENTION

This technology is generally related to an electrochemical device for energy storage, wherein the electrochemical device comprising a metal anode, a separator, a selenium-sulfur cathode with high mass loading, and an electrolyte comprising organic solvents, ionic-conducting salts, and additives.

### BACKGROUND

Alkaline metal sulfur batteries such as lithium-sulfur (Li—S) batteries have been widely considered as one of the most promising candidates for next-generation high energy density battery systems for portable devices and electrical vehicles due to their high theoretical energy density (2600 Wh kg⁻¹), low price (e.g., low price of S), and environmental benignity. As a result, Li—S batteries are of growing interest to both academia and industry, for developing practical battery systems with high realistic energy density, long cycle life, and high safety.

To achieve commercialization of Li—S batteries, certain requirements need to be fulfilled. First, the as-prepared cathode should deliver high specific capacity (i.e., high sulfur utilization) and good cycling stability under high S content, high areal S loading (e.g, ≥2.5 mg/cm², preferably ≥5 mg/cm²), and lean electrolyte (electrolyte/sulfur (E/S) ratio ≤10 μL/mgs) conditions. Second, reversible Li stripping/plating behavior should be ensured in a selected electrolyte system. Third, robust solid-electrolyte interphase (SEI) should be formed on the surface of an electrode in order to decrease side reactions and to prevent the formation of dendritic Li.

Previous research has revealed that the electrode/electrolyte interfacial property plays a key role in determining cell electrochemical behavior. As a result, developing an ideal electrolyte to well modify the cell electrochemical behavior is an efficient way to promote a Li—S battery to fulfill the above-mentioned requirements. It has been reported that high concentration electrolyte (HCE) and localized high concentration electrolyte (LHCE) can address the lithium polysulfides (LiPSs) dissolution issue and enable stable Li stripping/plating process so as to enhance the cycling stability of Li—S battery. However, due to the high viscosity and the lack of cathode SEI design, current electrolytes can only be applied in low-loading S cathode (≤2 mg/cm²) and flooding electrolyte (≥20 μL/mgs) conditions, resulting in a limited realistic cell specific energy. In addition, although these cells could demonstrate stable cycle life for up to thousands cycles in a coin cell with low S loading and excess electrolytes, a significant capacity fading can be observed in a practical pouch cell once the areal S loading is increased and/or the electrolyte amount is reduced [Adv. Energy Mater. 2015, 5, 1402290 & J. Electrochem. Soc. 2017, 164, A917].

Further, when a high areal capacity cathode is used under lean electrolyte conditions, the continuous parasitic reaction between Li metal and liquid electrolytes can result in electrolyte depletion of the cell, leading to a huge increase in cell internal resistance and sluggish cathode redox kinetics.

It has been described in U.S. Pat. No. 10,601,077 that highly fluorinated ether (HFE) electrolyte can effectively decrease the solubility of LiPSs so as to prevent capacity fading caused by LiPSs shuttling. However, the low LiPSs solubility can also slow down the electrochemical redox kinetics and reduce S utilization efficiency, particularly under high loading S cathode and/or lean electrolyte conditions. Additionally, stabilization of Li metal using a HFE electrolyte is not disclosed in this reference.

Therefore, new electrolyte compositions (e.g., including further design on the electrolyte composition as well as the electrolyte solvation structure) are needed to stabilize Li metal anode under high-loading S cathode and/or lean electrolyte conditions, so as to achieve batteries with high sulfur utilization and stable cycle life.

### SUMMARY

In one aspect, provided herein are electrochemical energy storage device comprising:
a sulfur or selenium-sulfur cathode;
a metal anode;
a separator; and
an electrolyte comprising:
   a conducting salt (Salt A) selected from the group consisting of lithium bis(trifluoromethanesulfonyl)imide, lithium bis(fluorosulfonyl)imide, sodium bis(trifluoromethanesulfonyl)imide, sodium bis(fluorosulfonyl)imide, potassium bis(trifluoromethanesulfonyl)imide, potassium bis(fluorosulfonyl)imide, magnesium bis(trifluoromethanesulfonyl)imide, magnesium bis(fluorosulfonyl)imide, aluminum bis(trifluoromethanesulfonyl)imide, aluminum bis(fluorosulfonyl)imide, calcium bis(trifluoromethanesulfonyl)imide, calcium bis(fluorosulfonyl)imide, and a combination of two or more thereof; and
   an SEI engineering salt (Salt B) selected from the group consisting of lithium tetrafluoroborate, lithium hexafluorophosphate, lithium difluoro(oxalato)borate, lithium perchlorate, lithium bis(fluorosulfonyl)imide, lithium hexafluoroarsenate(V), lithium hexafluoroantimonate, lithium triflate, lithium nonafluorobutanesulphonate, lithium 4,5-dicyano-2-(pentafluoroethyl) imidazolide, lithium 4,5-dicyano2-(trifluoromethyl) imidazolide, lithium fluoroalkyl phosphate, lithium bis(pentafluoroethanesulfonyl)imide and lithium nitrate; sodium tetrafluoroborate, sodium hexafluorophosphate, sodium difluoro(oxalato)borate, sodium perchlorate, sodium bis(fluorosulfonyl)imide, and sodium nitrate; potassium tetrafluoroborate, potassium hexafluorophosphate, potassium difluoro(oxalato)borate, potassium perchlorate, potassium bis(fluorosulfonyl)imide, and potassium nitrate; magnesium tetrafluoroborate, magnesium hexafluorophosphate, magnesium difluoro(oxalato)borate, magnesium perchlorate, magnesium bis(fluorosulfonyl)imide, and magnesium nitrate; aluminum tetrafluoroborate, aluminum hexafluorophosphate, aluminum difluoro(oxalato)borate, aluminum perchlorate, aluminum bis(fluorosulfonyl)imide, and aluminum nitrate; calcium tetrafluoroborate, calcium hexafluorophosphate, calcium difluoro(oxalato)borate, calcium perchlorate, calcium bis(fluorosulfonyl)imide, calcium nitrate, and a combination of two or more thereof,
   a dissolving solvent (Solvent C) selected from the group consisting of 1,2-dimethoxyethane, triethyl phosphate, trimethyl phosphate, acetonitrile, 2,5,8,11,14-pentaoxapentadecane, tetrahydrofuran, 2-methyltetrahydrofuran, di(ethylene glycol) dimethyl ether, tri(ethylene glycol) dimethyl ether, tetra(elene glycol) dimethyl ether (“TEGDME”), dimethyl sulfoxide, ethylene carbonate, dimethyl carbonate, ethyl methyl carbonate, oligo(ethylene glycol)-substituted siloxanes, oligo(ethylene glycol)-substituted silanes, and ionic liquids, and a combination of two or more thereof, and
   a diluent solvent (Solvent D) selected from the group consisting of 1,3-dioxolane, 1,1,2,2-tetrafluoroethyl-2,2,3,3-tetrafluoropropylether, bis(2,2,2-trifluoroethyl) ether, methy-1 1,1,2,2,3,3,4,4,4-nonafluorobutyl ether, 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; 4,5-difluoro-1,3-dioxolane, and a combination of two or more thereof,
wherein
   the cathode has an areal active material loading of about 2.5 mg·cm⁻² or greater; and
   the electrochemical device has an electrolyte to sulfur ratio of about 10.0 μL·mg⁻¹ or less.

In any of the embodiments herein, the areal active material loading may be from about 2.5 mg·cm⁻² to about 20.0 mg·cm⁻².

In any of the embodiments herein, the electrochemical device may have an electrolyte to sulfur ratio of about 10.0 μL·mg⁻¹ to about 0.5 μL·mg⁻¹.

In any of the embodiments herein, Solvent D and Solvent C may be present at a volume ratio from about 1 to about 100 Solvent D:Solvent C, or from about 2 to about 20 Solvent D:Solvent C, or from about 2 to about 5 Solvent D:Solvent C.

In any of the embodiments herein, Salt A may be present at about 0.01 mol·L⁻¹ to 5.0 mol·L⁻¹, at about 0.01 mol·L⁻¹ to 3 mol·L⁻¹, or at about 0.01 mol·L⁻¹ to 2 mol·L⁻¹.

In some embodiments, Salt B may be present at about 0.01 mol·L⁻¹ to 0.1 mol·L⁻¹, or at about 0.01 mol·L⁻¹ to 0.05 mol·L⁻¹.

In some embodiments, Salt A, may be lithium bis(trifluoromethanesulfonyl)imide; Salt B is lithium tetrafluoroborate, lithium difluoro(oxalato)borate, lithium hexafluorophosphate, or lithium bis(fluorosulfonyl)imide; Solvent C is 1,2-dimethoxyethane; and Solvent D is 1,1,2,2-tetrafluoroethyl-2,2,3,3-tetrafluoropropylether.

The sulfur or selenium-sulfur cathode may include: a sulfur/carbon electrochemical active composite or a selenium-sulfur/carbon composite; a conductive agent selected from the group consisting of Ketjenblack®, Super P® carbon black, core-shell carbon nanosphere, yolk-shell carbon nanosphere, ordered macroporous carbon framework, metal-organic framework, covalent organic framework, single-walled carbon nanotube, multi-walled carbon nanotube, graphene, reduced graphene oxide, graphene oxide, electro-spun carbon fiber, carbon paper, carbon cloth, and any combination of two or more thereof, and a binder selected from the group consisting of polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), and poly(9,9-dioctylfluorene-co-fluorenone-co-methylbenzoic ester), and any combination of two or more thereof.

In some embodiments, the selenium-sulfur/carbon composite may be described by a formula of [SₓSe_{y}]ₚ/[carbon]_{q}, wherein x, y, p, and q represent weight percentage values; and x>0, y>0, 0≤p≤100 wt. %, and 0≤q≤100 wt. %.

In some embodiments, p+q=100 wt. %, p may be greater than 0, and 0≤q<100.

In some embodiments, the binder may be a combination of carboxy methyl cellulose and styrene butadiene rubber with a weight ratio from about 0.5 to about 5 carboxy methyl cellulose:styrene butadiene rubber.

In some embodiments, the conductive carbon matrix may be selected from the group consisting of graphite, graphene, expanded graphite, reduced graphene oxide, acetylene black, Black Pearls® 2000, Ketjenblack®, carbon black, metal-organic framework (e.g., a porous, ordered organic-inorganic composite material), porous carbon, carbon spheres, carbon aerogel, single-walled carbon nanotubes, multi-walled carbon nanotubes, carbon nanofibers, carbon nanotube arrays, polypyrrole, polyaniline, and any combination of two or more thereof.

In some embodiments, the anode includes lithium, sodium, potassium, magnesium, aluminum, or calcium.

In another aspect, provided herein is a method of preparing a Se/S-carbon composite [SₓSe_{y}]ₚ/[carbon]_{q}, where the method includes: 1) mixing a selenium powder, a sulfur powder, and a conductive carbon matrix by ball-milling or grounding; and 2) subjecting material obtained from 1) to heat treatment under an inert atmosphere or vacuum to form the [SₓSe_{y}]ₚ/[carbon]_{q}composite; wherein the heating temperature is performed at a temperature of about 260° C. to about 600° C. for a time period of about 1 to about 24 h; x, y, p, and q represent weight percentage values; and x>0, y>0, 0≤p≤100 wt. %, and 0≤q≤100 wt. %.

### BRIEF DESCRIPTION OF THE DRAWINGS

FIG. 1 depicts a representative cycle performance of the electrochemical cell, according to Example 1 at 0.1 C with an areal S loading of 4.9 mg cm⁻² and an electrolyte-S ratio of 10 μL mg⁻¹.

FIG. 2 depicts a representative cycle performance of the electrochemical cell, according to Example 2 at 0.1 C with an areal S loading of 6.0 mg cm⁻² and an electrolyte-S ratio of 10 μL mg⁻¹.

FIG. 3 depicts representative cycle performance of electrochemical cells, according to Example 2 and Example 3 at 0.1 C with an areal S loading of 6.0 mg cm⁻² and an electrolyte-S ratio of 10 μL mg⁻¹.

FIG. 4 depicts representative cycle performance of electrochemical cells, according to Example 4 at 0.1 C.

FIG. 5 depicts representative cycle performance of electrochemical cells, according to Example 5 and Example 3 at 0.1 C with an areal S loading of 6.0 mg cm⁻² and an electrolyte-S ratio of 10 μL mg⁻¹.

FIG. 6 depicts representative cycle performance of electrochemical cells, according to Example 6 and Example 2 at 0.1 C with an areal S loading of 6.0 mg cm⁻² and an electrolyte-S ratio of 10 μL mg⁻¹.

FIG. 7 depicts representative cycle performance of electrochemical cells, according to Example 7 and Example 2 at 0.1 C with an areal S loading of 6.0 mg cm⁻² and an electrolyte-S ratio of 10 μL mg⁻¹.

FIG. 8 depicts representative cycle performance of electrochemical cells, according to Example 8 and Example 2 at 0.1 C with an areal S loading of 6.0 mg cm⁻² and an electrolyte-S ratio of 10 μL mg⁻¹.

FIG. 9 depicts representative cycle performance of the electrochemical cell, according to Example 9 at 0.1 C with an areal S loading of 6.0 mg cm⁻² and an electrolyte-S ratio of 7.0 μL mg⁻¹.

FIG. 10 depicts representative cycle performance of the electrochemical cell, according to Example 10 at 0.1 C with an areal S loading of 3.0 mg cm⁻² and an electrolyte-S ratio of 10 μL mg⁻¹.

FIG. 11A depicts representative cycle performance of the electrochemical cell, according to Example 11 and Example 3 at 0.1 C with an areal S loading of 3.5 mg cm⁻² and an electrolyte-S ratio of 10 μL mg⁻¹. FIG. 11B depicts charge and discharge voltage profiles of the electrochemical cell, according to Example 11.

FIG. 12 depicts representative cycle performance of the electrochemical cells, according to Example 12 at 0.1 C with an areal S loading of 6.0 mg cm⁻² and an electrolyte-S ratio of 10 μL mg⁻¹.

FIG. 13 depicts representative Li stripping/plating performance in different electrolytes, according to Example 13 at a current density of 0.5 mA cm⁻², and an areal capacity of 0.5 mAh cm⁻² and 1.0 mAh cm⁻², respectively.

FIG. 14 depicts representative Li symmetric cells performance in different electrolytes, according to Example 14 at a current density of 1.0 mA cm⁻² and an areal capacity of 3.0 mAh cm².

### DETAILED DESCRIPTION

The following terms are used throughout as defined below.

As used herein, “approximately” or “about” will be understood by persons of ordinary skill in the art and will vary to some extent depending upon the context in which it is used. If there are uses of the term which are not clear to persons of ordinary skill in the art, given the context in which it is used, “approximately” or “about” can mean up to plus or minus 10% of the particular term. For example, in certain some embodiments, the term “approximately” or “about” refers to a range of values that fall within 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The use of the terms “a” and “an” and “the” and similar references in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate the embodiments and does not pose a limitation on the scope of the claims unless otherwise stated. No language in the specification should be construed as indicating any non-claimed element as essential.

The inventions illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Additionally, the phrase “consisting essentially of” will be understood to include those elements specifically recited and those additional elements that do not materially affect the basic and novel characteristics of the claimed invention. The phrase “consisting of” excludes any element not specifically specified.

“Optional” or “optionally” means that the subsequently described event or circumstance may or may not occur, and that the description includes instances where the event or circumstance occurs and instances where it does not.

### The Present Technology

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The Electrolyte

In one aspect, provided herein is an electrolyte comprising a conducting salt A, an SEI engineering salt B, a solvent C, and a diluent solvent D. In some embodiments, conducting salt A is a salt that can provide ionic transport. In some embodiments, SEI engineering salt B is a salt that can tailor the interface of metal anode and cathode. In some embodiments, solvent C is a solvent that can dissolve conducting salt A and SEI engineering salt B. In some embodiments, diluent solvent D is a solvent that can tailor the solvation structure of electrolytes.

Illustrative examples of Salt A include, but are not limited to, bis(trifluoromethanesulfonyl)imide, lithium bis(fluorosulfonyl)imide, sodium, bis(trifluoromethanesulfonyl)imide, sodium bis(fluorosulfonyl)imide, potassium bis(trifluoromethanesulfonyl)imide, potassium bis(fluorosulfonyl)imide, magnesium bis(trifluoromethanesulfonyl)imide, magnesium bis(fluorosulfonyl)imide, aluminum bis(trifluoromethanesulfonyl)imide, aluminum bis(fluorosulfonyl)imide, calcium bis(trifluoromethanesulfonyl)imide, calcium bis(fluorosulfonyl)imide, and any combination of two or more thereof.

Illustrative examples of Salt B include, but are not limited to, lithium tetrafluoroborate, lithium hexafluorophosphate, lithium difluoro(oxalato)borate, lithium perchlorate, lithium bis(fluorosulfonyl)imide, lithium hexafluoroarsenate(V), lithium hexafluoroantimonate, lithium triflate, lithium nonafluorobutanesulphonate, lithium 4,5-dicyano-2-(pentafluoroethyl) imidazolide, lithium 4,5-dicyano2-(trifluoromethyl) imidazolide, lithium fluoroalkyl phosphate, lithium bis(pentafluoroethanesulfonyl)imide and lithium nitrate; sodium tetrafluoroborate, sodium hexafluorophosphate, sodium difluoro(oxalato)borate, sodium perchlorate, sodium bis(fluorosulfonyl)imide, and sodium nitrate; potassium tetrafluoroborate, potassium hexafluorophosphate, potassium difluoro(oxalato)borate, potassium perchlorate, potassium bis(fluorosulfonyl)imide, and potassium nitrate; magnesium tetrafluoroborate, magnesium hexafluorophosphate, magnesium difluoro(oxalato)borate, magnesium perchlorate, magnesium bis(fluorosulfonyl)imide, and magnesium nitrate; aluminum tetrafluoroborate, aluminum hexafluorophosphate, aluminum difluoro(oxalato)borate, aluminum perchlorate, aluminum bis(fluorosulfonyl)imide, and aluminum nitrate; calcium tetrafluoroborate, calcium hexafluorophosphate, calcium difluoro(oxalato)borate, calcium perchlorate, calcium bis(fluorosulfonyl)imide, calcium nitrate, and any combination of two or more thereof.

Illustrative examples of Solvent C include, but are not limited to, 1,2-dimethoxyethane, triethyl phosphate, trimethyl phosphate, acetonitrile, 2,5,8,11,14-pentaoxapentadecane, tetrahydrofuran, 2-methyltetrahydrofuran, di(ethylene glycol) dimethyl ether, tri(ethylene glycol) dimethyl ether, tetra(elene glycol) dimethyl ether (“TEGDME”), dimethyl sulfoxide, ethylene carbonate, dimethyl carbonate, ethyl methyl carbonate, oligo(ethylene glycol)-substituted siloxanes, oligo(ethylene glycol)-substituted silanes, ionic liquids, and any combination of two or more thereof.

Illustrative examples of Solvent D include, but are not limited to, 1,3-dioxolane, 1,1,2,2-tetrafluoroethyl-2,2,3,3-tetrafluoropropylether, bis(2,2,2-trifluoroethyl) ether, methy-1 1,1,2,2,3,3,4,4,4-nonafluorobutyl ether, 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; 4,5-difluoro-1,3-dioxolane; and any combination of two or more thereof.

In any of the embodiments herein, the volume ratio between Solvent D and Solvent C (V_{D}:V_{C}) in the electrolyte described herein may be from about 1 to about 100. This may include from about 10 to about 100, about 20 to about 100, about 30 to about 100, about 40 to about 100, about 50 to about 100, about 60 to about 100, about 70 to about 100, about 80 to about 100, or about 90 to about 100. In some embodiments, the volume ratio between Solvent D and Solvent C (V_{D}:V_{C}) is about 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 30.0, 40.0, 50.0, 60.0, 70.0, 80.0, 90.0 or 100.0, or any value therebetween. In some embodiments, the volume ratio between Solvent D and Solvent C (V_{D}:V_{C}) is about 2 to about 5, about 2 to about 10, or about 2 to about 20. In some embodiments, the volume ratio between Solvent D and Solvent C (V_{D}:V_{C}) is about 2 to about 6.

In embodiments, the concentration of Salt A in the electrolyte described herein may be from about 0.01 to about 5.0 mol L⁻¹. This may include from about 0.05 to about 5.0 mol L⁻¹, about 1.0 to about 5.0 mol L⁻¹, about 2.0 to about 5.0 mol L⁻¹, about 0.05 to about 3.0 mol L⁻¹, or about 0.1 to about 2.0 mol L⁻¹. In some embodiments, the concentration of Salt A is about 0.01, 0.05, 0.1, 0.15, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 mol L⁻¹, or any value therebetween. In some embodiments, the concentration of Salt A is about 0.01 mol L⁻¹ to about 3 mol L⁻¹, about 0.01 mol L⁻¹ to about 2 mol L⁻¹, about 1 mol L⁻¹ to about 3 mol L⁻¹, or about 1 mol L⁻¹ to about 2 mol L⁻¹.

In some embodiments, the concentration of Salt B in the electrolyte described herein may be from 0.001 to 0.1 mol L⁻¹. In some embodiments, the concentration of Salt B is about 0.005 mol L⁻¹, about 0.01 mol L⁻¹, about 0.015 mol L⁻¹, about 0.02 mol L⁻¹, about 0.025 mol L⁻¹, about 0.03 mol L⁻¹, about 0.035 mol L⁻¹, about 0.04 mol L⁻¹, about 0.045 mol L⁻¹, about 0.05 mol L⁻¹, about 0.055 mol L⁻¹, about 0.06 mol L⁻¹, about 0.065 mol L⁻¹, about 0.07 mol L⁻¹, about 0.075 mol L⁻¹, about 0.08 mol L⁻¹, about 0.085 mol L⁻¹, about 0.09 mol L⁻¹, about 0.095 mol L⁻¹, about 0.1 mol L⁻¹ mol L⁻¹, or any value therebetween. In some embodiments, the concentration of Salt B is about 0.01 mol L⁻¹ to about 0.1 mol L⁻¹, about 0.01 mol L⁻¹ to about 0.05 mol L⁻¹, or about 0.04 mol L⁻¹ to about 0.06 mol L⁻¹.

In some embodiments, an electrolyte described herein comprises 1) a Salt A that is lithium bis(trifluoromethanesulfonyl)imide; 2) a Salt B that is lithium tetrafluoroborate, lithium difluoro(oxalato)borate, lithium hexafluorophosphate, or lithium bis(fluorosulfonyl)imide; 3) a Solvent C that is 1,2-dimethoxyethane; and 4) a Solvent D that is 1,1,2,2-tetrafluoroethyl-2,2,3,3-tetrafluoropropylether; wherein the volume ratio between Solvent D and Solvent C (V_{D}:V_{C}), the concentration of Salt A, and/or the concentration of Salt B, are according to any embodiments as described herein.

The Electrochemical Energy Storage Device

In another aspect, provided herein is an electrochemical energy storage device comprising a metal anode, a separator, an electrolyte (e.g., an electrolyte as described herein), and a sulfur or selenium-sulfur cathode (e.g., a high-mass-loading selenium-sulfur cathode). In some embodiments, the electrochemical energy storage device described in the present technology comprises a high-mass-loading cathode and/or a lean electrolyte. For example, In some embodiments, the cathode of an electrochemical energy storage device described herein has an areal active material loading of about 2.5 mg·cm⁻² or greater. In some embodiments, the cathode of an electrochemical energy storage device described herein has an electrolyte to sulfur ratio of about 10.0 μL·mg⁻¹ or less.

In some embodiments, the energy storage device described herein is a lithium metal battery, a sodium metal battery, a potassium metal battery, a magnesium metal battery, an aluminum metal battery, or a calcium metal battery. In some embodiments, the metal anode of an electrochemical energy storage device described herein comprises one or more of lithium, sodium, potassium, magnesium, aluminum, and calcium.

In some embodiments, the sulfur or selenium-sulfur cathode (e.g., the high-mass-loading cathode) of an electrochemical energy storage device described herein comprise a sulfur/carbon electrochemical active composite (e.g., a sulfur/carbon electrochemical active composite as described herein) or a selenium-sulfur/carbon composite (e.g., a selenium-sulfur/carbon composite as described herein), a conductive agent (e.g., a conductive agent as described herein), and a binder (e.g., a binder as described herein).

In embodiments, the weight ratio between the selenium-sulfur/carbon composite (W_{Se/S—C}) and conductive agent (W_{ca}) is from about 0.1 to about 10 W_{Se/S—C}:W_{ca}. In some embodiments, the weight ratio between the selenium-sulfur/carbon composite and conductive agent (W_{Se/S—C}:W_{ca}) is about 0.1, about 0.5, about 1, about 2, about 3, about 4, about 5, about 6, about 7, about 8, about 9, about 10, or any value therebetween. In some embodiments, the weight ratio between the selenium-sulfur/carbon composite (W_{Se/S—C}) and binder (W_{b}) is from about 0.1 to about 10 W_{Se/S—C}:W_{b}. In some embodiments, the weight ratio between the selenium-sulfur/carbon composite and binder (W_{Se/S—C}:W_{b}) is about 0.1, about 0.5, about 1, about 2, about 3, about 4, about 5, about 6, about 7, about 8, about 9, about 10, or any value therebetween. In some embodiments, the weight ratio between the conductive agent (W_{ca}) and binder (W_{b}) is from about 0.1 to about 10 W_{ca}:W_{b}. In some embodiments, the weight ratio between the conductive agent and binder (W_{ca}:W_{b}) is about 0.1, about 0.5, about 1, about 2, about 3, about 4, about 5, about 6, about 7, about 8, about 9, about 10, or any value therebetween.

In embodiments, the sulfur or selenium-sulfur cathode described herein is a high-mass-loading cathode (e.g., a high-mass-loading selenium-sulfur cathode). For example, the cathode (e.g., the high-mass-loading selenium-sulfur cathode) described herein can have an areal active material loading of about 2.5 mg·cm⁻² or greater, or about 5 mg·cm⁻² or greater. In some embodiments, the cathode (e.g., the high-mass-loading selenium-sulfur cathode) described herein has an areal active material loading of about 2.5 mg·cm⁻² to about 20 mg·cm⁻². In some embodiments, the cathode (e.g., the high-mass-loading selenium-sulfur cathode) described herein has an areal active material loading of about 3.0 mg·cm⁻² to about 10.0 mg·cm⁻² or about 5.0 mg·cm⁻² to about 10.0 mg·cm⁻². In some embodiments, the cathode (e.g., the high-mass-loading selenium-sulfur cathode) described herein has an areal active material loading of about 2.5 mg·cm⁻², about 3.0 mg·cm⁻², about 4.0 mg·cm⁻², about 5.0 mg·cm⁻², about 6.0 mg·cm⁻², about 7.0 mg·cm⁻², about 8.0 mg·cm⁻², about 9.0 mg·cm⁻², about 10.0 mg·cm⁻², about 11.0 mg·cm², about 12.0 mg·cm⁻², about 13.0 mg·cm⁻², about 14.0 mg·cm⁻², about 15.0 mg·cm⁻², about 16.0 mg·cm⁻², about 17.0 mg·cm⁻², about 18.0 mg·cm⁻², about 19.0 mg·cm⁻², about 20.0 mg·cm⁻², or any value therebetween.

In some embodiments, the sulfur or selenium-sulfur cathode (e.g., the high-mass-loading selenium-sulfur cathode) described herein comprises a conductive agent. Illustrative conductive agent includes but is not limited to, Ketjenblack®, Super P® carbon black, core-shell carbon nanosphere, yolk-shell carbon nanosphere, ordered macroporous carbon framework, metal-organic framework, covalent organic framework, single-walled carbon nanotube, multi-walled carbon nanotube, graphene, reduced graphene oxide, graphene oxide, electro-spun carbon fiber, carbon paper, carbon cloth, and any combination of two or more thereof.

In some embodiments, the sulfur or selenium-sulfur cathode (e.g., the high-mass-loading selenium-sulfur cathode) described herein comprises a binder. Illustrative binder includes but is not limited to polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), and poly(9,9-dioctylfluorene-co-fluorenone-co-methylbenzoic ester), and any combination of two or more thereof. In some embodiments, the binder is styrene butadiene rubber and carboxy methyl cellulose with a weight ratio between 0.5 and 5.

In some embodiments, the binder is present in the cathode electrode (e.g., the sulfur or selenium-sulfur cathode such as the high-mass-loading selenium-sulfur cathode) in an amount from about 0.1 wt. % to about 20 wt. %. In some embodiments, the binder is present in the cathode electrode (e.g., the sulfur or selenium-sulfur cathode such as the high-mass-loading cathode) in an amount of about 0.1 wt. %, about 0.5 wt. %, about 1 wt. %, about 2 wt. %, about 3 wt. %, about 4 wt. %, about 5 wt. %, about 6 wt. %, 7 wt. %, about 8 wt. %, about 9 wt. %, about 10 wt. %, about 12 wt. %, about 14 wt. %, about 16 wt. %, about 18 wt. %, about 20 wt. %, and about 8 wt. %, about 8 wt. %, about 8 wt. %, about 8 wt. %, or any value therebetween.

In some embodiments, the selenium-sulfur cathode (e.g., the high-mass-loading selenium-sulfur cathode) described herein comprises a selenium-sulfur/carbon composite. In some embodiments, the selenium-sulfur/carbon composite comprises selenium-sulfur and a conductive carbon matrix. The selenium-sulfur/carbon composite may generally be described by formula [SₓSe_{y}]ₚ/[carbon]_{q}, wherein x, y, p and q represent the weight percentage values. In some embodiments, x>0, y>0, 0≤p≤100%, 0≤q≤100%. In some embodiments, p+q=100 wt. %, p is greater than 0, and 0≤q<100.

In embodiments, S and Se are present in the selenium-sulfur/carbon composite (e.g., a selenium-sulfur/carbon composite as described herein) in a form of multi-phase microstructures. For example, the multi-phase microstructure can include an amorphous or crystalline phase of S, Se, SₓSe_{y}, or any combination thereof. In some embodiments, the selenium-sulfur/carbon composite comprises amorphous particles (e.g., amorphous particles of S, Se, SₓSe_{y}, or any combination thereof). In some embodiments, the selenium-sulfur/carbon composite comprises crystalline particles (e.g., crystalline particles of S, Se, SₓSe_{y}, or any combination thereof). In some embodiments, the amorphous particle may have a particle size of about 1 nm to about 20 nm. In some embodiments, an amorphous particle may have a particle size of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, or any value therebetween. In some embodiments, the crystalline particle may have a particle size of about 50 to about 500 nm. In some embodiments, the crystalline particle may have a particle size of about 60 nm, about 70 nm, about 80 nm, about 90 nm, about 100 nm, about 200 nm, about 300 nm, about 400 nm, about 500 nm, or any value therebetween.

In some embodiments, the [SₓSe_{y}]ₚ/[carbon]_{q} composite described herein may have a SₓSe_{y} content of about 0.1% to about 99.9% by weight of the composite. In some embodiments, the [SₓSe_{y}]ₚ/[carbon]_{q} composite described herein may have a SₓSe_{y} content of about 0.1% to about 99%, about 0.1% to about 90%, about 0.1% to about 80%, about 50% to about 90%, about 50% to about 70%, or about 70% to about 90%, by weight of the composite. In some embodiments, the [SₓSe_{y}]ₚ/[carbon]_{q} composite has a SₓSe_{y} content of about 0.1%, about 0.5%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25%, about 30%, about 35%, about 40%, about 45%, about 50%, about 55%, about 60%, about 65%, about 70%, about 75%, about 80%, about 85%, about 90%, about 95%, about 99%, about 99.9%, or any value therebetween, by weight of the composite.

In some embodiments, the selenium-sulfur cathode (e.g., the high-mass-loading selenium-sulfur cathode) described herein comprises a conductive carbon matrix. Illustrative conductive carbon matrix includes, but is not limited to, graphite, graphene, expanded graphite, reduced graphene oxide, acetylene black, carbon black (e.g., Black Pearls® 2000 and Ketjenblack®), metal-organic framework (e.g., a porous, ordered organic-inorganic composite material), porous carbon, carbon spheres, carbon aerogel, single-walled carbon nanotubes, multi-walled carbon nanotubes, carbon nanofibers, carbon nanotube arrays, polypyrrole, polyaniline, and any combination of two or more thereof.

In some embodiments, the conductive carbon matrix described herein comprises one or more of graphite, graphene, expanded graphite, reduced graphene oxide, acetylene black, carbon black, metal-organic framework (e.g., a porous, ordered organic-inorganic composite material), porous carbon, carbon spheres, carbon aerogel, single-walled carbon nanotubes, multi-walled carbon nanotubes, carbon nanofibers, carbon nanotube arrays, polypyrrole, and polyaniline.

In some embodiments, the conductive carbon matrix described herein comprises one or more of graphite, graphene, expanded graphite, reduced graphene oxide, acetylene black, carbon black, metal-organic framework (e.g., a porous, ordered organic-inorganic composite material), porous carbon, carbon spheres, and carbon aerogel.

In further embodiments, the conductive carbon matrix described herein comprises one or more of single-walled carbon nanotubes, multi-walled carbon nanotubes, carbon nanofibers, carbon nanotube arrays, polypyrrole, and polyaniline.

In some embodiments, the conductive carbon matrix described herein may have a high specific surface area. For example, the high specific surface area can ensure good cathode redox kinetics, and can enable a uniform dispersion of selenium-doped sulfur particles in the Se/S-carbon composite, which then will facilitate electron and ion transportation. In some embodiments, the high specific surface area may be about 50 to about 2000 m² g⁻¹. In some embodiments, the high specific surface area is about 100 m² g⁻¹, about 200 m² g⁻¹, about 300 m² g⁻¹, about 400 m² g⁻¹, about 500 m² g⁻¹, about 600 m² g⁻¹, about 700 m² g⁻¹, about 800 m² g⁻¹, about 900 m² g⁻¹, about 1000 m² g⁻¹, about 1100 m² g⁻¹, about 1200 m² g⁻¹, about 1300 m² g⁻¹, about 1400 m² g⁻¹, about 1500 m² g⁻¹, about 1600 m² g⁻¹, about 1700 m² g⁻¹, about 1800 m² g⁻¹, about 1900 m² g⁻¹, about 2000 m² g⁻¹, or any value therebetween.

In embodiments, the [SₓSe_{y}]ₚ/[carbon]_{q} composite described herein may have a carbon matrix content of about 1% to about 70% by weight of the composite. In some embodiments, the [SₓSe_{y}]ₚ/[carbon]_{q} composite described herein has a carbon matrix content of about 1% to about 60% by weight of the composite. In some embodiments, the [SₓSe_{y}]ₚ/[carbon]_{q} composite described herein has a carbon matrix content of about 1% to about 50% by weight of the composite. In some embodiments, the [SₓSe_{y}]ₚ/[carbon]_{q} composite described herein has a carbon matrix content of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25%, about 30%, about 35%, about 40%, about 45%, about 50%, about 55%, about 60%, about 65%, or about 70%, or any value therebetween, by weight of the composite. In some embodiments, the [SₓSe_{y}]ₚ/[carbon]_{q} composite described herein has a carbon matrix content of about 10% to about 50%, about 20% to about 40%, about 10% to about 30%, or about 30% to about 50%, by weight of the composite.

Preparation of the [SₓSe_{y}]ₚ/[Carbon]_{q} Composite.

In another aspect, provided herein is a method for preparing a [SₓSe_{y}]ₚ/[carbon]_{q} composite (e.g., a [SₓSe_{y}]ₚ/[carbon]_{q} composite as described herein), comprising 1) mixing an amount (e.g., an amount calculated according to the weight ratio in any embodiments described herein) of a selenium powder, a sulfur powder, and a conductive carbon matrix; 2) subjecting material obtained in step 1) to heat treatment under an inert atmosphere or vacuum. In some embodiments, the mixing step is performed by ball milling. In some embodiments, the mixing step is performed by grounding.

In some embodiments, the weight ratio between selenium powder and sulfur powder (w_{Se}:w_{S}) may be from about 0.01 to about 99. In some embodiments, the weight ratio between selenium powder and sulfur powder (w_{Se}:w_{S}) may be about 0.01, about 0.1, about 1, about 2, about 3, about 4, about 5, about 10, about 15, about 20, about 25, about 30, about 35, about 40, about 45, about 50, about 55, about 60, about 65, about 70, about 75, about 80, about 85, about 90, about 95, about 99, or any value therebetween.

In some embodiments, the method comprises subjecting the mixture obtained in step 1) to heat treatment, wherein the temperature of heat treatment may be from about 120° C. to about 600° C. In some embodiments, the temperature of heat treatment is about 260° C. to about 600° C. In some embodiments, the temperature of heat treatment is about 120° C., about 130° C., about 140° C., about 150° C., about 160° C., about 170° C., about 180° C., about 190° C., about 200° C., about 250° C., about 300° C., about 350° C., about 400° C., about 450° C., about 500° C., about 550° C., about 600° C., or any value therebetween.

In some embodiments, the heat treatment can be performed for a time period from about 1 h to about 24 h. In some embodiments, the heat treatment is performed for about 1 h, about 2 h, about 3 h, about 4 h, about 5 h, about 6 h, about 7 h, about 8 h, about 9 h, about 10 h, about 11 h, about 12 h, about 13 h, about 14 h, about 15 h, about 16 h, about 17 h, about 18 h, about 19 h, about 20 h, about 21 h, about 22 h, about 23 h, about 24 h, or any value therebetween.

In some embodiments, the mixing step is conducted by ball milling (e.g., ball milling of the selenium powder, sulfur powder, and carbon matrix). For example, uniform distribution of the active materials (e.g., the selenium, sulfur, and carbon matrix) inside the selenium-sulfur/carbon composite can be achieved, which can then improve the active material utilization efficiency.

In some embodiments, a ball milling step of a method described herein may be performed at a rotation speed of about 200 to about 1500 rpm. In some embodiments, the ball milling may be performed at a rotation speed of about 200 rpm, about 300 rpm, about 400 rpm, about 500 rpm, about 600 rpm, about 700 rpm, about 800 rpm, about 900 rpm, about 1000 rpm, about 1100 rpm, about 1200 rpm, about 1300 rpm, about 1400 rpm, or about 1500 rpm, or any value therebetween.

In some embodiments, the ball milling (e.g., ball milling of the selenium powder, sulfur powder, and carbon matrix) may be performed under inert gas protection to avoid oxidization of active material. The inert gas may be selected from nitrogen, argon, and helium.

In some embodiments, a ball milling step of a method described herein may be performed for a time period of about 1 to about 24 hours. For example, the ball milling time can determine the particle size and the active material uniformity. In some embodiments, the ball milling is performed for a time period of about 1 to about 15 hours. In some embodiments, the ball milling is performed for a time period of about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours, or any value therebetween.

Preparation of the High-Mass-Loading Cathode.

In a related aspect, provided herein is a method for preparing the high-mass-loading cathode as described herein, comprising casting a slurry comprising the selenium-sulfur/carbon composite (e.g., the selenium-sulfur/carbon composite as described herein), conductive agent (e.g., the conductive agent as described herein), and binder (e.g., the binder as described herein) on the surface of a current collector. In some embodiments, the weight ratio among the selenium-sulfur/carbon composite (W_{Se/S—C}), conductive agent (W_{ca}), and/or binder (W_{b}) in the slurry is according to any embodiments described herein.

In some embodiments, the slurry is prepared by ball milling the ingredients such as the selenium-sulfur/carbon composite, conductive agent, and binder, at a rotation speed from about 50 to about 1500 rpm (including a rotation speed according to any embodiments described herein). The ball milling time may be from about 0.5 to about 30 min (including a milling time according to any embodiments described herein). During slurry casting, the height of the electrode scraper blade may be from 50 μm to 1000 μm.

The present invention, thus generally described, will be understood more readily by reference to the following examples, which are provided by way of illustration and are not intended to be limiting of the present invention.

### EXAMPLES

The following examples illustrate some embodiments and aspects of the invention. It will be apparent to those skilled in the relevant art that various modifications, additions, substitutions, and the like can be performed without altering the spirit or scope of the invention, and such modifications and variations are encompassed with invention as defined in the claims which follow. The invention disclosed herein is further illustrated by the following examples which in no way should be construed as being limiting.

### Example 1. Cycling Performance of Li—S Cell in the Electrolyte with No Diluent Solvent D and No SEI Engineering Salt B

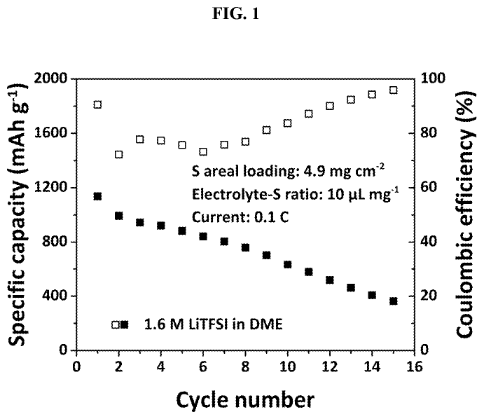

An electrochemical cell was prepared by using the electrolyte with no diluent solvent D and no SEI engineering salt B to demonstrate their effect in boosting the performance of Li—S cell with high mass loading and lean electrolytes. The electrolyte used in this example was composed of 1.6 M LiTFSI in 1,2-dimethoxyethane (DME). The areal S loading was controlled at ˜4.9 mg cm⁻² and the E/S ratio was controlled at 10 μL mg⁻¹. As shown in FIG. 1, although the cell delivered an initial specific capacity of 1136.27 mAh g⁻¹ (i.e., 67.8% sulfur utilization), the LiPSs shuttling was very severe, as the Coulombic efficiency of the first 10 cycles was below 80%. Therefore, the cell specific capacity was decreased to only 362.62 mAh g⁻¹ within 15 cycles.

### Example 2. Cycling Performance of Li—S Cell in Common DME/DOL Electrolyte

The most common electrolyte for Li—S cell is composed of 1.0 M LiTFSI (salt A) as the main salt, and the 1,2-dimethoxyethane (DME)/1,3-dioxolane (DOL) with the volume ratio of 1:1 as the solvent C and solvent D, respectively, and 0.1 M LiNO₃ as the salt B.

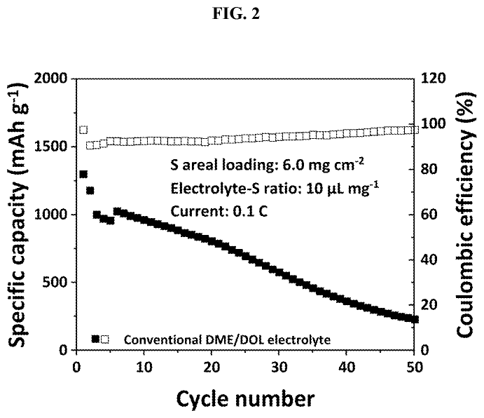

Cycle performance of a cell comprising above electrolyte (i.e., 1.0 M LiTFSI as main salt, 0.1 M LiNO₃ as salt B, in DME/DOL solvent with a volume ratio of 1:1) was examined. However, as shown in FIG. 2, when working with a high areal S loading cathode (6.0 mg·cm⁻²) and a low E/S ratio of 10 μL mg⁻¹, the cathode specific capacity faded very quickly, and it only maintained a specific capacity of 232.3 mAh g⁻¹ for 50 cycles, corresponding to a capacity retention rate of 17.85%.

### Example 3. Comparison of Cycling Performance of Li—S Cells in ANL-1 Electrolyte and the Common DME/DOL Electrolyte with High Areal S Loading Cathode

Cycling performance of Li—S cells comprising a high areal S loading cathode was examined in ANL-1 electrolyte and the common DME/DOL electrolyte.

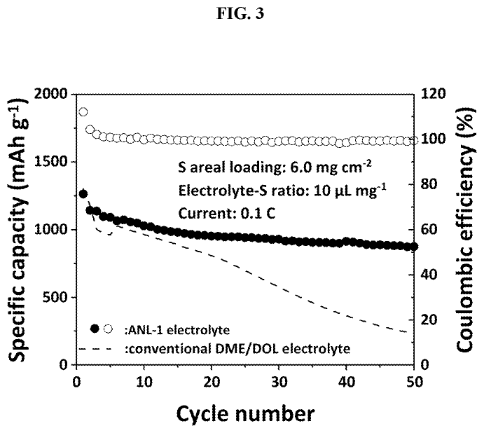

The ANL-1 electrolyte was composed of 1.6 M LiTFSI (salt A) in 1,1,2,2-tetrafluoroethyl-2,2,3,3-tetrafluoropropylether (HFE)/DME (v/v=10/3) as solvent D and solvent C, respectively, with 0.05 M LiBF₄ as the salt B. The unique solvation structure of ANL-1 electrolyte can effectively inhibit the flooding of dissolved LiPSs, preventing the cell capacity fading caused by the LiPSs shuttling. Moreover, the LiBF₄ additive not only induced the formation of B-containing SEI on the surface of Li metal anode, but also helped to form the CEI on the surface of S cathode. Therefore, due to the modification of electrolyte solvation structure as well as the SEI/CEI surface properties regulation, the cycling stability of the Li—S cell in the ANL-1 electrolyte was greatly enhanced even with a high areal S loading cathode (6.0 mg cm⁻²) and a low E/S ratio of 10 μL mg⁻¹. As shown in FIG. 3, the Li—S cell in ANL-1 electrolyte delivered a high initial specific capacity of 1263.2 mAh g⁻¹ (corresponding to 75.4% sulfur utilization), and it maintained a high specific capacity of 875.3 mAh g⁻¹ after 50 cycles, demonstrating better performance than that in the conventional DME/DOL electrolytes (Example 2).

### Example 4. Optimization of the Concentration of LiBF₄ Additive Inside the Electrolyte

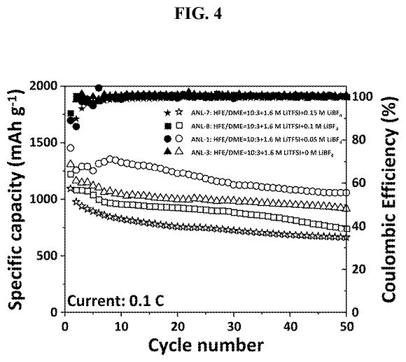

Since the SEI and CEI were formed due to the reaction/decomposition of electrolyte molecules on the surface of electrodes, in order to optimize the electrode interphase properties, electrolytes with different concentrations of LiBF₄ additive were prepared and tested in Li—S cells. As shown in FIG. 4, Different LiBF₄ concentrations from 0 M to 0.15 M were compared. The Li—S cell with ANL-3 (0 M LiBF₄) delivered an initial specific capacity of 1309.9 mAh g⁻¹, and it maintained a specific capacity of 917.1 mAh g⁻¹. The electrolyte with the 0.05 M LiBF₄ concentrations showed the best cell performance with a high initial specific capacity of 1455.1 mAh g⁻¹ (corresponding to 86.8% sulfur utilization) and a high specific capacity of 1057.5 mAh g⁻¹ after 50 cycles. In addition, further increase on the concentration of LiBF₄ (e.g., to 0.1 M and 0.15 M) reduced the electrochemical performance of Li—S cell.

### Example 5. Comparison of Cycling Performance of Li—S Cells in Electrolytes with Different Solvation Structures

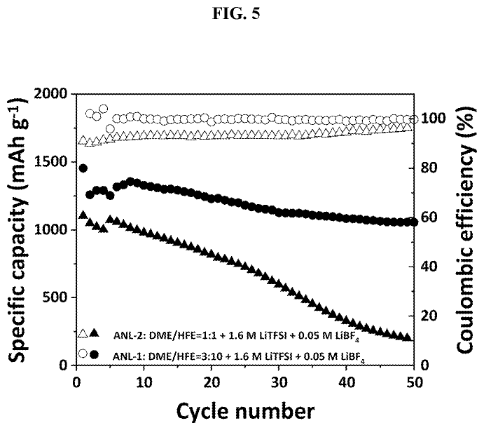

Cycling performance of Li—S cells in electrolytes with different solvation structures (e.g., different solvents) was examined. The electrolyte solvating structure is important in determining the solubility of S redox intermediates (LiPSs), which can be significantly affected by the volume ratio of solvents in the electrolytes. When the volume ratio of HFE/DME was decreased to 1, the number of free DME molecules inside the electrolyte would increase, which would increase the electrolyte solubility of LiPSs. The flooding of LiPSs would result in severe capacity fading due to the shuttle effect. More importantly, because of the increasing number of dissolved LiPSs, the reaction between LiBF₄ and LiPSs would intensify, which would lead to the continuous consumption of electrolyte additives and the electrode active material. As a result, as shown in FIG. 5, the capacity of the Li—S cell with the ANL-2 electrolyte faded rapidly, and it only delivered a capacity retention rate of 18.08% for 50 cycles. By contrast, for the case with a modified solvating structure (ANL-1 electrolyte), the cycling stability, as well as the S utilization efficiency, were greatly enhanced.

### Example 6. Comparison of the Cycling Performance of Li—S Cells in Conventional DME/DOL Electrolyte and the Electrolyte with LiDFOB Additive

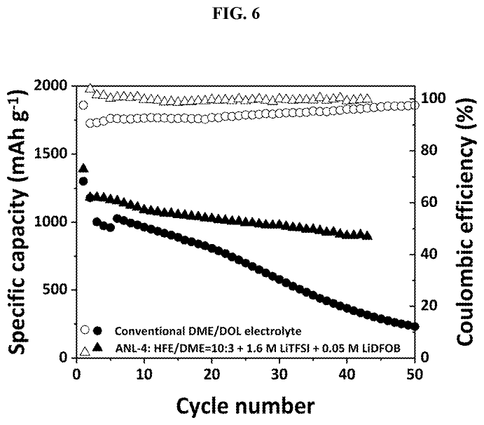

The cell performance of the Li—S cells with other SEI engineering salt B were carried out. As shown in FIG. 6, for the Li—S cell in the conventional DME/DOL electrolyte, due to the severe LiPSs shuttle effect, the cell capacity faded very quickly. By contrast, in the ANL-5 electrolyte with 0.05M LiDFOB additive as the SEI engineering salt B, due to the unique SEI formed on the anode and cathode surface, the cycling stability was greatly enhanced. This example confirms that the Lewis acid salt LiDFOB can be used as additive in the electrolyte with the solvating structure design.

### Example 7. Comparison of the cycling performance of Li—S cells in conventional DME/DOL electrolyte and the electrolyte with LiPF₆ additive

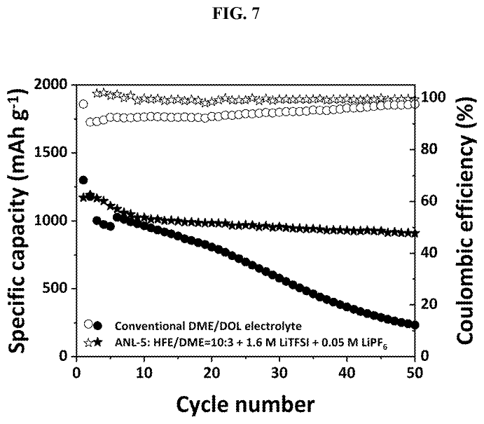

The cell performance of the Li—S cells with other SEI engineering salts were carried out. As shown in FIG. 7, for the Li—S cell in conventional DME/DOL electrolyte, the cell capacity faded very quickly due to the severe LiPSs shuttle effect. However, in the ANL-6 electrolyte with 0.05M LiPF₆ additive as SEI engineering salt B, due to the unique SEI formed on the anode and cathode surface, the cycling stability was greatly enhanced, and it delivered a capacity retention rate of 77.6% for 50 cycles. This example confirms that the Lewis acid salt LiPF₆ can be used as additive in the electrolyte with the solvating structure design.

### Example 8. Comparison of the Cycling Performance of Li—S Cells in Conventional DME/DOL Electrolyte and the Electrolyte with LiFSI Additive

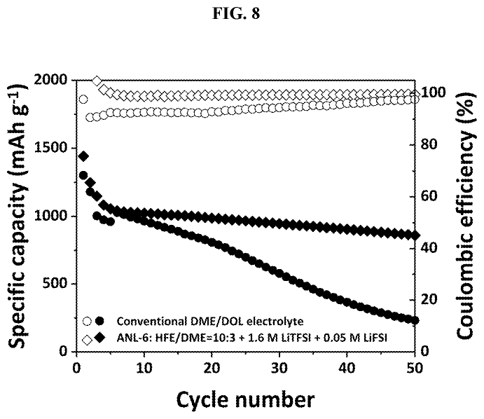

The cell performance of the Li—S cells with other SEI engineering salts were carried out. As shown in FIG. 8, for the Li—S cell in conventional DME/DOL electrolyte, the cell capacity faded very quickly due to the severe LiPSs shuttle effect. However, in ANL-7 electrolyte with 0.05M LiFSI additive as SEI engineering salt B, due to the unique SEI formed on the anode and cathode surface, the cycling stability was greatly enhanced, and it delivered a specific capacity of 858.9 mAh g⁻¹ after 50 cycles. This example confirms that the Lewis acid salt LiFSI can be used as the additive in the electrolyte with the solvating structure design.

### Example 9. Cycling Performance of Li—S Cell in the Electrolyte with the Present Solvating Structure Design as Well as the LiBF₄ Additive Under a Lower Electrolyte-S Ratio

The cell's realistic specific energy is mainly affected by the cathode specific capacity and the amount of electrolyte used in the cell. In order to truly push forward the commercialization of Li—S batteries, the Li—S cell performance under high-loading S cathode and lean electrolyte conditions need to be improved.

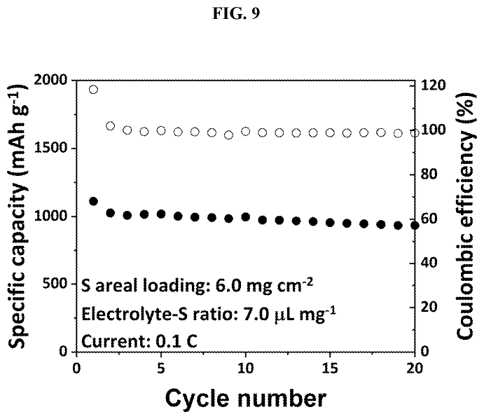

In order to validate the potential of the practical application of Li—S cell based on the present electrolyte design, Li—S cell performance under high-loading S cathode (6.0 mg cm⁻²) and a lower electrolyte-S ratio (7.0 μL mg⁻¹) of ANL-1 was further tested. As shown in FIG. 9, due to the unique interphase engineering through solvating structure and additive modifications, the Li—S cell under practical conditions still delivered a high specific capacity of 1111.3 mAh g⁻¹ under the current of 0.1 C. Moreover, the Li—S cell with the present electrolyte design also delivered a high specific capacity of 934.1 mAh g⁻¹ after 20 cycles under thick cathode and lean electrolyte working conditions. This example further validates the potential of practical application based on the present technology.

### Example 10. Li—S Cell Performance Under the Low-Temperature Condition in ANL-1 Electrolyte

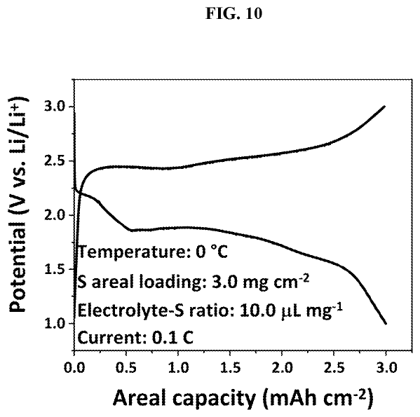

The cell performance under low-temperature condition is very important, especially for electric vehicle applications in high latitudes areas. Thus, the performance of the Li—S cell with the ANL-1 electrolyte was further evaluated under 0° C. As shown in FIG. 10, even under low-temperature condition, the Li—S cell with ANL-1 electrolyte still delivered a high areal capacity of ˜3.0 mAh cm⁻² with the areal S loading of 3.0 mg cm⁻², corresponding to a high specific capacity of ˜1000 mAh g⁻¹. The good electrochemical performance of Li—S cell under low temperature further validates the future practical application of Li—S cell based on this electrolyte design.

### Example 11. Cycling Performance and Voltage Profiles of Li—S Cell in the Electrolyte with Different Solvating Structure Design

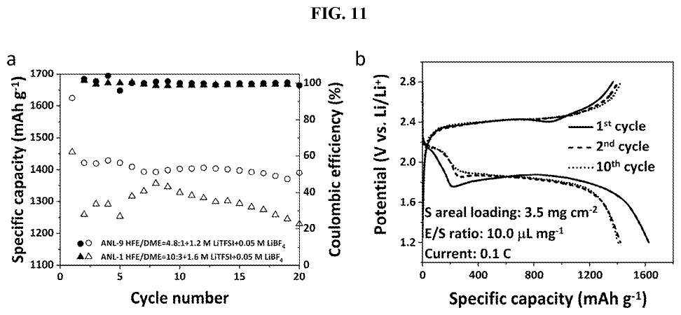

The electrolyte solvating structure can play an important role in determining the electrochemical and physical properties, such as ionic conductivity, viscosity, density, etc., the Li—S cells comprising electrolytes with further diluted solvating structures (ANL-9: 1.2 M LiTFSI in HFE/DME (v/v=4.8/1) with 0.05 M LiBF₄ additive) was further tested. As shown in FIG. 11, in terms of cell capacity and cycling stability, the performance of Li—S cell in ANL-9 electrolyte was further enhanced. The cell with ANL-9 electrolyte can achieve a high initial specific capacity of 1625 mAh g⁻¹ (corresponding to ca. 97% sulfur utilization), and it can maintain a specific capacity of 1390.2 mAh g⁻¹ after 20 cycles. This example suggests that the electrolyte solvating structure design greatly influences cell performance, and a suitable solvating structure design should be adopted to meet the various requirements under different working conditions.

### Example 12. Comparison of the Cycling Performance of Li—S Cells in HFE/DOL Electrolyte and the ANL-1 Electrolyte

The HFE/DOL electrolyte is composed of 1.0 M LiTFSI in HFE/DOL (v/v=1/1) with 0.1 M LiNO₃ additive, and the introduction of highly fluorinated ether solvent can effectively prevent the LiPSs flooding to stabilize the Li—S cell. However, due to the DOL polymerization induced by the Lewis-acid salt, the choice of SEI/CEI engineering salt for the DOL-based electrolyte is very limited, and the lack of SEI/CEI design can affect the Li—S cell performance, especially under thick cathode and lean electrolyte condition.

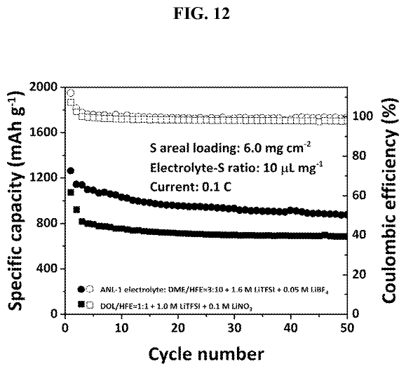

Comparison of the cycling performance of Li—S cells in HFE/DOL electrolyte and the ANL-1 electrolyte was conducted. As shown in FIG. 12, Li—S cell with a thick cathode in the HFE/DOL electrolyte only delivered a specific capacity of ˜800 mAh g⁻¹, which was much lower than the specific capacity of a cell comprising ANL-1 electrolyte.

### Example 13. Comparison of the Cycling Performance of Li—Cu Cells in Conventional DME/DOL Electrolyte and ANL-1 Electrolyte

The Li metal stripping/plating stability can be very important for Li—S batteries.

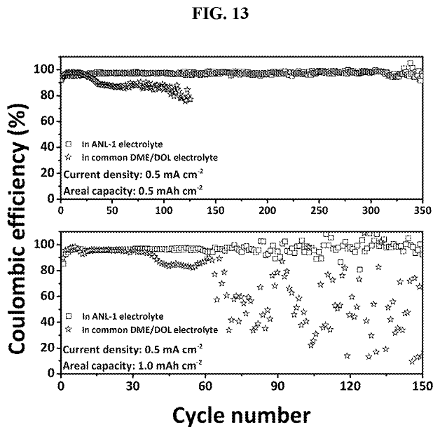

Li—Cu cells in conventional DME/DOL electrolyte and ANL-1 electrolyte were further tested to evaluate the Li stripping/plating stabilities. As shown in FIG. 13, when the areal capacity was set as 0.5 mAh cm⁻², the Li—Cu cell only delivered a stable cycle performance for 30 cycles, and the cell Coulombic efficiency suddenly decreased afterward, indicating a poor Li stripping/plating behavior in conventional DME/DOL electrolyte. In contrast, in the cell comprising ANL-1 electrolyte, due to the unique solvating structure and the involvement of SEI engineering salts, the as-assembled Li—Cu cell delivered a stable cycling performance for 350 cycles with a high Coulombic efficiency >97%. When the areal capacity was increased to 1.0 mAh cm⁻², the stability of Li—Cu cell in conventional DME/DOL electrolyte was further reduced. However, for the cell comprising ANL-1 electrolyte, good cycling stability and high Coulombic efficiency were well maintained.

### Example 14. Comparison of the Cycling Performance of Li Symmetric Cells in Conventional DME/DOL Electrolyte and ANL-1 Electrolyte

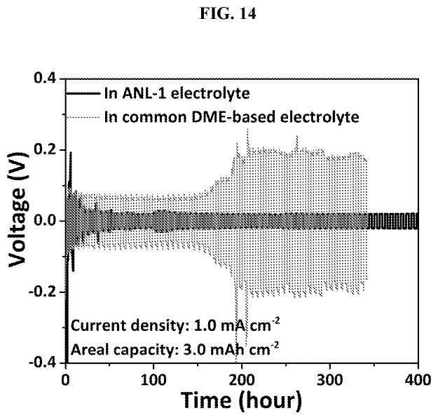

To further evaluate the Li stripping/plating stability under high areal capacity and large current density conditions, the Li∥Li symmetric cells in conventional DME/DOL electrolyte and ANL-1 electrolyte were further tested with the current density of 1.0 mA cm⁻² and the areal capacity of 3.0 mAh cm⁻². As shown in FIG. 14, in the conventional electrolyte, the Li∥Li symmetric cell only delivered a stable cycle performance for ˜150 h with a large overpotential of ˜80 mV. By contrast, in the case of ANL-1 electrolyte, due to the unique solvating structure combined with the SEI engineering salts, the Li∥Li symmetric cell delivered a stable cycling performance for over 400 h with a much smaller overpotential of ˜20 mV.

While certain some embodiments have been illustrated and described, it should be understood that changes and modifications can be made therein in accordance with ordinary skill in the art without departing from the technology in its broader aspects as defined in the following claims.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical energy storage device comprising:
a sulfur or selenium-sulfur cathode;
a metal anode;
a separator; and
an electrolyte comprising:
a conducting salt (Salt A) selected from the group consisting of lithium bis(trifluoromethanesulfonyl)imide, lithium bis(fluorosulfonyl)imide, sodium bis(trifluoromethanesulfonyl)imide, sodium bis(fluorosulfonyl)imide, potassium bis(trifluoromethanesulfonyl)imide, potassium bis(fluorosulfonyl)imide, magnesium bis(trifluoromethanesulfonyl)imide, magnesium bis(fluorosulfonyl)imide, aluminum bis(trifluoromethanesulfonyl)imide, aluminum bis(fluorosulfonyl)imide, calcium bis(trifluoromethanesulfonyl)imide, calcium bis(fluorosulfonyl)imide, and a combination of two or more thereof; and
an SEI engineering salt (Salt B) selected from the group consisting of lithium tetrafluoroborate, lithium hexafluorophosphate, lithium difluoro(oxalato)borate, lithium perchlorate, lithium bis(fluorosulfonyl)imide, lithium hexafluoroarsenate(V), lithium hexafluoroantimonate, lithium triflate, lithium nonafluorobutanesulphonate, lithium 4,5-dicyano-2-(pentafluoroethyl) imidazolide, lithium 4,5-dicyano2-(trifluoromethyl) imidazolide, lithium fluoroalkyl phosphate, lithium bis(pentafluoroethanesulfonyl)imide and lithium nitrate; sodium tetrafluoroborate, sodium hexafluorophosphate, sodium difluoro(oxalato)borate, sodium perchlorate, sodium bis(fluorosulfonyl)imide, and sodium nitrate; potassium tetrafluoroborate, potassium hexafluorophosphate, potassium difluoro(oxalato)borate, potassium perchlorate, potassium bis(fluorosulfonyl)imide, and potassium nitrate; magnesium tetrafluoroborate, magnesium hexafluorophosphate, magnesium difluoro(oxalato)borate, magnesium perchlorate, magnesium bis(fluorosulfonyl)imide, and magnesium nitrate; aluminum tetrafluoroborate, aluminum hexafluorophosphate, aluminum difluoro(oxalato)borate, aluminum perchlorate, aluminum bis(fluorosulfonyl)imide, and aluminum nitrate; calcium tetrafluoroborate, calcium hexafluorophosphate, calcium difluoro(oxalato)borate, calcium perchlorate, calcium bis(fluorosulfonyl)imide, calcium nitrate, and a combination of two or more thereof,
a dissolving solvent (Solvent C) selected from the group consisting of 1,2-dimethoxyethane, triethyl phosphate, trimethyl phosphate, acetonitrile, 2,5,8,11,14-pentaoxapentadecane, tetrahydrofuran, 2-methyltetrahydrofuran, di(ethylene glycol) dimethyl ether, tri(ethylene glycol) dimethyl ether, tetra(elene glycol) dimethyl ether (“TEGDME”), dimethyl sulfoxide, ethylene carbonate, dimethyl carbonate, ethyl methyl carbonate, oligo(ethylene glycol)-substituted siloxanes, oligo(ethylene glycol)-substituted silanes, and ionic liquids, and a combination of two or more thereof, and
a diluent solvent (Solvent D) selected from the group consisting of 1,3-dioxolane, 1,1,2,2-tetrafluoroethyl-2,2,3,3-tetrafluoropropylether, bis(2,2,2-trifluoroethyl) ether, methy-1 1,1,2,2,3,3,4,4,4-nonafluorobutyl ether, 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; 4,5-difluoro-1,3-dioxolane, and a combination of two or more thereof,
wherein
the cathode has an areal active material loading of about 2.5 mg·cm⁻² or greater; and
the electrochemical device has an electrolyte to sulfur ratio of about 10.0 μL·mg⁻¹ or less.

2. The electrochemical device of claim 1, wherein the areal active material loading is from about 2.5 mg·cm⁻² to about 20.0 mg·cm⁻².

3. The electrochemical device of claim 1, wherein the electrochemical device has an electrolyte to sulfur ratio of about 10.0 μL·mg⁻¹ to about 0.5 μL·mg⁻¹.

4. The electrochemical device of claim 1, wherein Solvent D and Solvent C are present at a volume ratio from about 1 to about 100 Solvent D:Solvent C.

5. The electrochemical device of claim 4, wherein Solvent D and Solvent C are present at a volume ratio from about 2 to about 20 Solvent D:Solvent C.

6. The electrochemical device of claim 5, wherein Solvent D and Solvent C are present at a volume ratio from about 2 to about 5 Solvent D:Solvent C.

7. The electrochemical device of claim 1, wherein Salt A is present at about 0.01 mol·L⁻¹ to 5.0 mol·L⁻¹.

8. The electrochemical device of claim 7, wherein Salt A is present at about 0.01 mol·L⁻¹ to 3 mol·L⁻¹.

9. The electrochemical device of claim 8, wherein Salt A is present at about 0.01 mol·L⁻¹ to 2 mol·L⁻¹.

10. The electrochemical device of claim 1, wherein Salt B is present at about 0.01 mol·L⁻¹ to 0.1 mol·L⁻¹.

11. The electrochemical device of claim 10, wherein Salt B is present at about 0.01 mol·L⁻¹ to 0.05 mol·L⁻¹.

12. The electrochemical device of claim 1, wherein
Salt A is lithium bis(trifluoromethanesulfonyl)imide;
Salt B is lithium tetrafluoroborate, lithium difluoro(oxalato)borate, lithium hexafluorophosphate, or lithium bis(fluorosulfonyl)imide;
Solvent C is 1,2-dimethoxyethane; and
Solvent D is 1,1,2,2-tetrafluoroethyl-2,2,3,3-tetrafluoropropylether.

13. The electrochemical device of claim 1, wherein the sulfur or selenium-sulfur cathode comprises:
a sulfur/carbon electrochemical active composite or a selenium-sulfur/carbon composite;
a conductive agent selected from the group consisting of Ketjenblack®, Super P® carbon black, core-shell carbon nanosphere, yolk-shell carbon nanosphere, ordered macroporous carbon framework, metal-organic framework, covalent organic framework, single-walled carbon nanotube, multi-walled carbon nanotube, graphene, reduced graphene oxide, graphene oxide, electro-spun carbon fiber, carbon paper, carbon cloth, and any combination of two or more thereof, and
a binder selected from the group consisting of polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), and poly(9,9-dioctylfluorene-co-fluorenone-co-methylbenzoic ester), and any combination of two or more thereof.

14. The electrochemical device of claim 13, wherein the selenium-sulfur/carbon composite is described by a formula of [SₓSe_{y}]ₚ/[carbon]_{q}, wherein
x, y, p, and q represent weight percentage values; and
x>0, y>0, 0≤p≤100 wt. %, and 0≤q≤100 wt. %.

15. The electrochemical device of claim 14, wherein p+q=100 wt. %, p is greater than 0, and 0≤q<100.

16. The electrochemical device of claim 13, wherein the binder is a combination of carboxy methyl cellulose and styrene butadiene rubber with a weight ratio from about 0.5 to about 5 carboxy methyl cellulose:styrene butadiene rubber.

17. The electrochemical device of claim 13, wherein the conductive carbon matrix is selected from the group consisting of graphite, graphene, expanded graphite, reduced graphene oxide, acetylene black, Black Pearls® 2000, Ketjenblack®, carbon black, metal-organic framework (e.g., a porous, ordered organic-inorganic composite material), porous carbon, carbon spheres, carbon aerogel, single-walled carbon nanotubes, multi-walled carbon nanotubes, carbon nanofibers, carbon nanotube arrays, polypyrrole, polyaniline, and any combination of two or more thereof.

18. The electrochemical device of claim 1, wherein the anode comprises lithium, sodium, potassium, magnesium, aluminum, or calcium.

19. A method of preparing a Se/S-carbon composite [SₓSe_{y}]ₚ/[carbon]_{q}, comprising
1) mixing a selenium powder, a sulfur powder, and a conductive carbon matrix by ball-milling or grounding; and
2) subjecting material obtained from 1) to heat treatment under an inert atmosphere or vacuum to form the [SₓSe_{y}]ₚ/[carbon]_{q} composite;
wherein
the heating temperature is performed at a temperature of about 260° C. to about 600° C. for a time period of about 1 to about 24 h;
x, y, p, and q represent weight percentage values; and
x>0, y>0, 0≤p≤100 wt. %, and 0≤q≤100 wt. %.
